(19) United States
(12) Patent Application Publication
(10) Pub. No.: US 2016/0108939 A1
(43) Pub. Date: Apr. 21, 2016

(54) HYDRAULIC DRIVE FOR A PRESSURE BOOSTER

(71) Applicant: BHDT GmbH, Kapfenberg (AT)

(72) Inventors: Franz TRIEB, Kapfenberg (AT); Rene STUEHLINGER, Oberaich (AT); Rene MODERER, Tragoess (AT)

(73) Assignee: BHDT GMBH, Kapfenberg (AT)

(21) Appl. No.: 14/557,867

(22) Filed: Dec. 2, 2014

(30) Foreign Application Priority Data
Oct. 20, 2014 (AT) A50746/2014

(51) Int. Cl. F15B 15/14

(52) U.S. Cl. CPC F15B 15/149

(57) ABSTRACT

Hydraulic drive for pressure booster of a high-pressure apparatus, having an electric servo drive effectively connected to electrical supply operable to be regulated and/or switched by measurement signals; a hydraulic pump, pumping a constant volume of working fluid per revolution, and driven by the electric servo drive, and measuring devices for a pressure and/or a pressure trend of the working fluid and/or a pressure and/or a pressure trend of the high-pressure fluid and/or for a position of a piston in the pressure booster. Servo drive is embodied bidirectionally, such that an application of working fluid to the pressure booster is reversible. Control of regulating and/or switching parameters of the electrical supply of the servo drive is based on signals from the measuring devices for the pressure and/or the pressure trend of the working fluid and/or the high-pressure fluid and/or for the position of the piston in the pressure booster.

### CROSS-REFERENCE TO RELATED APPLICATIONS

The present application claims priority under 35 U.S.C. §119 of Austrian Patent Application No. A50746/2014, filed Oct. 20, 2014, the disclosure of which is expressly incorporated by reference herein in its entirety.

### BACKGROUND OF THE DISCLOSURE

1. Field of the Disclosure

Embodiments relate to a hydraulic drive for a pressure booster in a fluid high-pressure apparatus, in particular for a system for water jet cutting, essentially comprising a hydraulic pump, which pumps a constant volume of working fluid per revolution, driven by an electric servo drive, effectively connected to an electrical supply which can be regulated and/or switched by measurement signals.

2. Discussion of Background Information

Hydraulic drives for pressure boosters that are driven using a variable servo drive constitute the state of the art.

In AT 512 322 B1, for example, a hydraulic drive is disclosed which comprises a constant displacement pump with a controllable servo drive, with which constant displacement pump working fluid can be applied to a pressure booster comprising two pistons by a switching block.

A redirection of an application of a working fluid, which is normally supplied by the pump at a pressure of approximately 300 bar, to the respective working piston surfaces occurs, as described above, by a switching block or a reversing block.

On the one hand, a switching block for the alternating impingement of the working piston surfaces of the pressure booster constitutes a large constructional effort and, on the other hand, can, particularly during a redirection of the pressurized working fluid, introduce surges into the hydraulic high-pressure system, which thus produces a superimposed mechanical peak load on the parts in addition to the static base load.

### SUMMARY OF THE EMBODIMENTS OF THE DISCLOSURE

The aim of embodiments of the disclosure is now to create a hydraulic drive for a pressure booster of a fluid high-pressure apparatus of the type named at the outset, which hydraulic drive results in low pressure fluctuations in the high-pressure system, thus reduces the peaks of the material loads and ensures higher reliability, and also simplifies the system design and has economic advantages.

This aim is attained in that the servo drive is embodied bidirectionally, that is, as a reversible motor, and that an application of working fluid to the pressure booster can thus be reversed, wherein a control of the regulating parameters and/or the switching parameters of the electrical supply of the servo drive is based on signals from measuring devices for a pressure and/or pressure trend of the working fluid and/or a pressure and/or a pressure trend of the high-pressure fluid and/or for the position of the plunger in the pressure booster.

The advantages attained with the embodiments of the disclosure are, in particular, that an alternating application of working fluid to the respective working piston surface of a pressure booster occurs directly from a hydraulic pump with a constant volume pumping per revolution, driven bidirectionally by a servo drive.

A redirection of a pressurized working fluid by a switching block according to the prior art, which by its nature can cause surges, is thus avoided and, according to embodiments of the disclosure, a gentle pressure buildup in the working fluid is achieved within milliseconds or short spans of time during the startup of a servo drive.

The simplicity of the mechanical design, the high operational reliability and the efficiency of high-pressure apparatuses of this type can be seen as another advantage.

A particularly advantageous embodiment of the drive according to the disclosure for a pressure booster is attained if, in the region of the conveying of the working fluid between a hydraulic pump and a pressure booster and/or in the region of a supply in a container, at least one heat exchanger is positioned in the conveying element and/or in the container for adjusting the temperature of the working fluid.

In this manner, desired or optimal temperatures of the working fluid can be adjusted for a heavy operation of a pressure booster.

If, according to the disclosure, the conveying elements or lines between a hydraulic pump and a pressure booster each comprise an element for feeding working fluid into the system of the hydraulic drive, a slight overpressure over the atmosphere can, respectively during a return feed of working fluid from the pressure booster to the hydraulic pump, be set in the working fluid. Optimal starting conditions for the pressure side of the hydraulic drive or of the pump can thus be set. Low overpressure values of 0 bar to approximately 5 bar have proven themselves, where necessary, for preventing a gas formation.

Other exemplary embodiments and advantages of the present disclosure may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of exemplary embodiments of the present disclosure, in which like reference numerals represent similar parts throughout the several views of the drawings, and wherein:

FIG. 1 shows a hydraulic drive of a pressure booster with an element for feeding working fluid into the system.

FIG. 2 shows a hydraulic drive for a pressure booster with a heat exchanger.

The following list of reference numerals is intended to provide easier association of the parts and components in the illustrations.
1 hydraulic drive
10 working fluid
11 pump
12 electric servo drive
13 low-pressure measurement transducer
14 high-pressure measurement transducer
15 electrical feed and control
16 piston-travel sensor
2 pressure booster
21 supply device for high-pressure fluid
3 high-pressure line
31 pulsation damper
32 pressure relief valve
4 working fluid feed system
40 drive motor of the feed pump
41 feed element with check valve
42 feed element with check valve
5 heat exchanger in the feed system
51 heat exchanger in the supply container
52 heat exchanger in the conveying element
53 heat exchanger in the conveying element

### DETAILED DESCRIPTION

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the embodiments of the present disclosure in more detail than is necessary for the fundamental understanding of the present disclosure, the description taken with the drawings making apparent to those skilled in the art how the several forms of embodiments of the present disclosure may be embodied in practice.

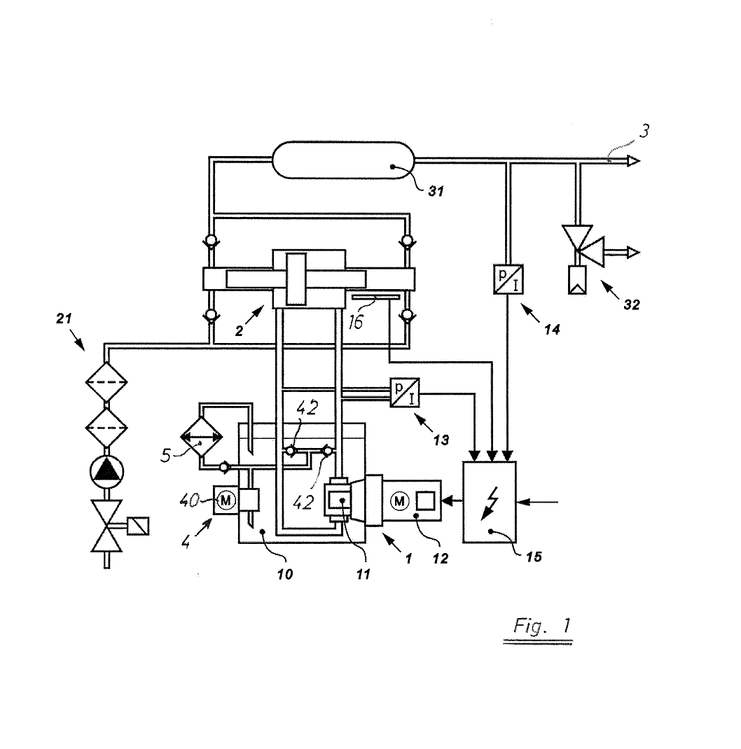

FIG. 1 shows a fluid high-pressure apparatus with a hydraulic drive 1 for a pressure booster 2.

A constant-displacement pump 11 can be driven by a servo drive 12. A controlled feed 15 of the servo motor 12 regulates the rotation parameters thereof and the stopping thereof.

With the use of a low-pressure measurement transducer 13 and/or a high-pressure measurement transducer 14 and/or a piston travel sensor 16 of the pressure booster 2, the motor operation and thus the pumping of working fluid by the pump 11 and, therefore, an impingement of the respective working piston surface of the pressure booster 2 are program-controlled.

A feed system 4 for working fluid comprises, for example, a feed pump with a drive motor 40, which pump is connected to the respective conveying elements between the hydraulic pump 11 and pressure booster 2 by check valves 41, 42.

A feed system of this type can also comprise a heat exchanger 5, by which the temperature of the working fluid can be adjusted in the storage container.

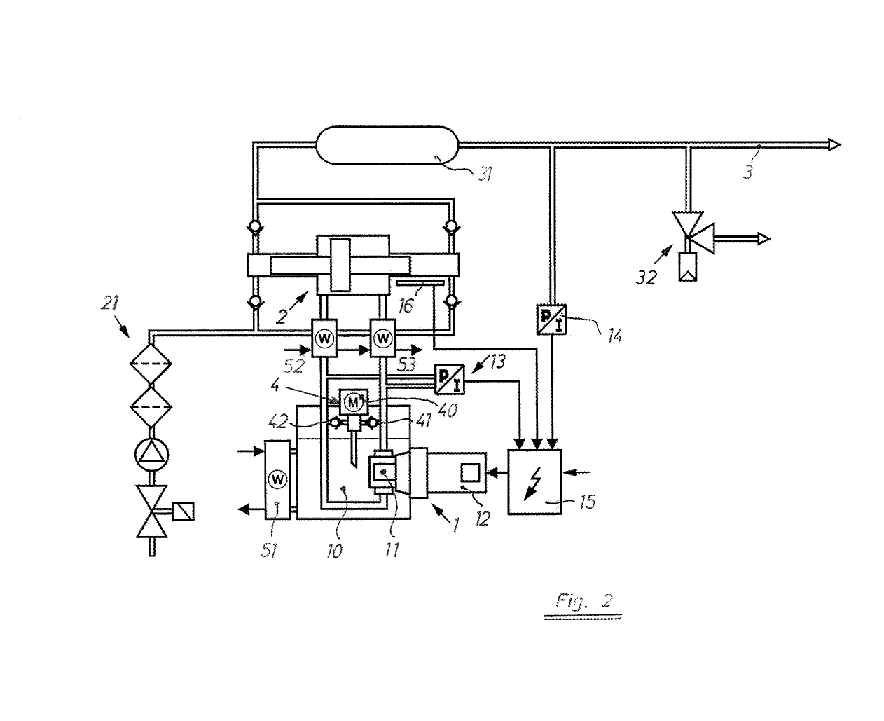

FIG. 2 essentially shows parts of a hydraulic drive 1 for a pressure booster 2 according to FIG. 1.

However, a different embodiment is illustrated for a cooling according to the invention of the working fluid.

A heat exchanger 51 for the working fluid can be arranged in the region of a supply container 10, and/or the conveying elements from the hydraulic pump 11 to the pressure booster 2 each comprise a heat exchanger 52, 53.

It is noted that the foregoing examples have been provided merely for the purpose of explanation and are in no way to be construed as limiting of the present disclosure. While the present disclosure has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although embodiments of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A hydraulic drive for a pressure booster of a high-pressure apparatus, comprising:
an electric servo drive effectively connected to an electrical supply operable to be regulated and/or switched by measurement signals;
a hydraulic pump, which pumps a constant volume of working fluid per revolution, which is driven by the electric servo drive, and
measuring devices for a pressure and/or a pressure trend of the working fluid and/or a pressure and/or a pressure trend of the high-pressure fluid and/or for a position of a piston in the pressure booster,
wherein the servo drive is embodied bidirectionally as a reversible motor such that an application of working fluid to the pressure booster is reversible,
wherein a control of regulating parameters and/or switching parameters of the electrical supply of the servo drive is based on the signals from the measuring devices for the pressure and/or the pressure trend of the working fluid and/or the pressure and/or the pressure trend of the high-pressure fluid and/or for the position of the piston in the pressure booster.

2. The hydraulic drive according to claim 1, further comprising at least one heat exchanger arranged in a region of a conveying of the working fluid between the hydraulic pump and the pressure booster in a conveying element and/or in the region of a supply of the hydraulic pump and the pressure booster in a container for adjusting the temperature of the working fluid.

3. The hydraulic drive according to claim 1, further comprising conveying elements for the working fluid between the hydraulic pump and the pressure booster, wherein the conveying elements for the working fluid between the hydraulic pump and the pressure booster each comprise an element for feeding working fluid into the hydraulic drive.

4. The hydraulic drive according to claim 1, structured and arranged for a system for water jet cutting.

5. A method of driving a hydraulic drive for a pressure booster of a high-pressure apparatus, comprising:
regulating and/or switching an electric servo drive effectively connected to an electrical supply by measurement signals;
driving a hydraulic pump, which pumps a constant volume of working fluid per revolution, by the electric servo drive, and
measuring a pressure and/or a pressure trend of the working fluid and/or a pressure and/or a pressure trend of a high-pressure fluid and/or for a position of a piston in the pressure booster,
wherein the servo drive is embodied bidirectionally as a reversible motor such that an application of working fluid to the pressure booster is reversible,
wherein a control of regulating parameters and/or switching parameters of the electrical supply of the servo drive is based on the signals from the measuring devices for the pressure and/or the pressure trend of the working fluid and/or the pressure and/or the pressure trend of the high-pressure fluid and/or for the position of the piston in the pressure booster.

6. The method of driving the hydraulic drive for the pressure booster according to claim 5, to drive a system for water jet cutting.
